(19) United States
(12) Patent Application Publication
(10) Pub. No.: US 2011/0063520 A1
(43) Pub. Date: Mar. 17, 2011

(54) Multimedia System and Remote Control Searching Method

(76) Inventor: Xie-Ren Hsu, Hsinchu City (TW)

(21) Appl. No.: 12/772,240

(22) Filed: May 3, 2010

(30) Foreign Application Priority Data
Sep. 11, 2009 (TW) 098130678

(51) Int. Cl. H04N 5/44; G08B 5/22

(52) U.S. Cl. 348/734; 348/E05.096

(57) ABSTRACT

A multimedia system includes a multimedia device and a remote control device. The multimedia device includes a trigger element, a detection unit and a wireless transmitter. The trigger element is utilized for generating a trigger signal. The detection unit is coupled to the trigger element, and is utilized for generating a searching signal when the trigger signal is detected. The wireless transmitter is coupled to the detection unit, and is utilized for wirelessly transmitting the searching signal. The remote control device is utilized for wirelessly transmitting a remote control signal to control operations of the multimedia device. The remote control device includes a wireless receiver and an alarm unit. The wireless receiver is utilized for receiving the searching signal. The alarm unit is coupled to the wireless receiver, and is utilized for generating an alarm effect according to the searching signal.

### BACKGROUND OF THE INVENTION

1. Field of the Invention

The present invention relates to a multimedia system and remote control searching method, and more particularly, to a multimedia system and remote control searching method capable of enhancing use convenience.

2. Description of the Prior Art

With advances in multimedia technology, a variety of multimedia devices has become a part of life. For example, consumer multimedia products, such as televisions, stereos, projectors, digital versatile disk players, etc., are widely used by people. To enable users to easily control various functions, most of the multimedia devices are equipped with remote controls, such that the users are allowed to control the multimedia devices through the remote controls at will.

When the users want to control the multimedia device to perform a function through the remote control, the users can press a button corresponding to the function on the remote control, such that a wireless signal sent by the remote control would carry specific information corresponding to the function. After receiving the remote control signal, the multimedia device can interpret the specific information in the remote control signal, and perform the related function accordingly.

However, since the remote controls are small-sized, light-weighted and portable, they are easily taken to other places or even forgotten. Therefore, the users often need to spend some time searching for the remote controls before they can comfortably watch TV programs. If the remote controls cannot be found immediately, the users can only rely on buttons on televisions to perform channel selection, causing great inconvenience to the users.

For this reason, the multimedia systems in the prior art have to be improved.

### SUMMARY OF THE INVENTION

It is therefore a primary objective of the present invention to provide a multimedia system and remote control searching method, for enhancing convenience.

The present invention discloses a multimedia system, which includes a multimedia device and a remote control device. The multimedia device includes a trigger element, a detection unit and a wireless transmitter. The trigger element is utilized for generating a trigger signal. The detection unit is coupled to the trigger element, and is utilized for generating a searching signal when detecting the trigger signal. The wireless transmitter is coupled to the detection unit, and is utilized for wirelessly transmitting the searching signal. The remote control device is utilized for wirelessly transmitting a remote control signal to control operations of the multimedia device. The remote control device includes a wireless receiver and an alarm unit. The wireless receiver is utilized for receiving the searching signal. The alarm unit is coupled to the wireless receiver, and is utilized for generating an alarm effect according to the searching signal.

The present invention further discloses a remote control searching method of a multimedia device, for searching a remote control device corresponding to the multimedia device. The remote control device is utilized for wirelessly transmitting a remote control signal to control operations of the multimedia device. The remote control searching method includes generating a trigger signal; generating a searching signal according to the trigger signal; and wirelessly transmitting the searching signal to enable the remote control device to generate an alarm effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a multimedia system according to an embodiment of the present invention.

FIG. 1B is a functional block diagram of the multimedia system in FIG. 1A.

FIG. 2 is a schematic diagram of a remote control searching method according to an embodiment of the present invention.

### DETAILED DESCRIPTION

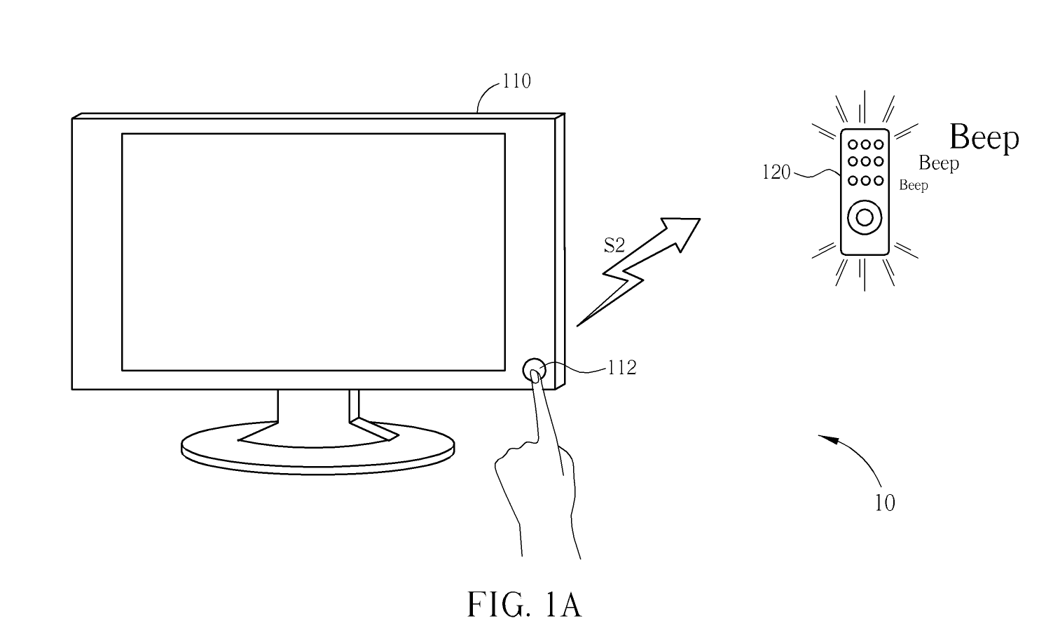

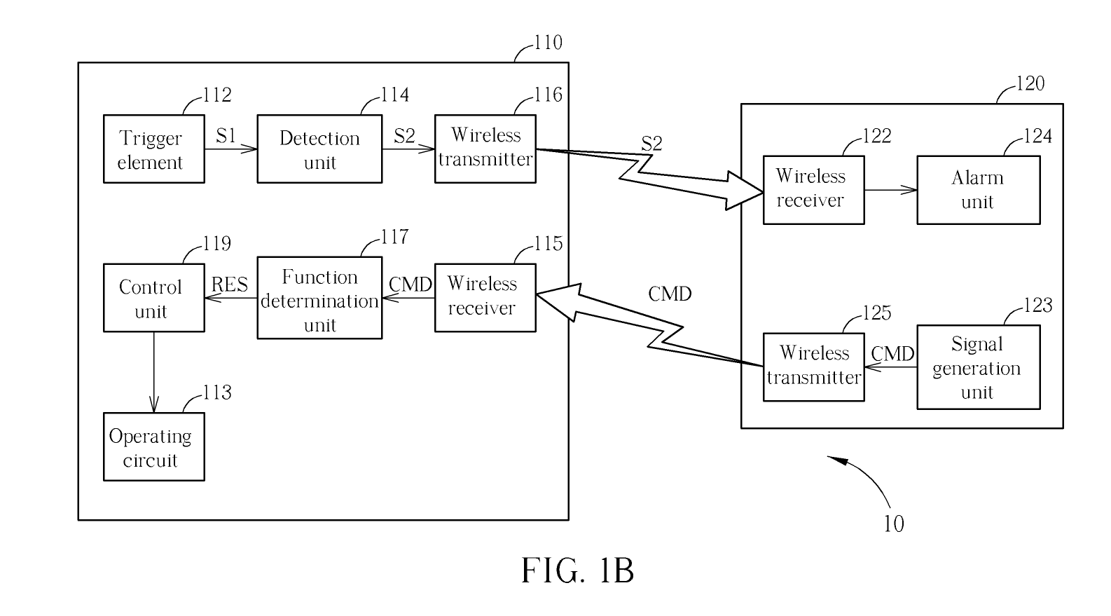

Please refer to FIG. 1A and FIG. 1B. FIG. 1A is a schematic diagram of a multimedia system 10 according to an embodiment of the present invention, and FIG. 1B is a functional block diagram of the multimedia system 10 in FIG. 1A. The multimedia system 10 includes a multimedia device 110 and a remote control device 120. The multimedia device 110 is preferably a television, and includes a trigger element 112, a detection unit 114 and a wireless transmitter 116. The trigger element 112 can be a button or a touch pad installed on the multimedia device 110, and is utilized for generating a trigger signal S1. The detection unit 114 is coupled to the trigger element 112, and is utilized for generating a searching signal S2 when detecting the trigger signal S1. The wireless transmitter 116 is coupled to the detection unit 114, and is utilized for transmitting the searching signal S2 by a wireless way, such as by infrared, radio frequency (RF), wireless network, etc. The remote control device 120 is utilized for wirelessly controlling operations of the multimedia device 110, and includes a wireless receiver 122 and an alarm unit 124. The wireless receiver 122 is utilized for receiving the searching signal S2. The alarm unit 124 is coupled to the wireless receiver 122, and is utilized for generating an alarm effect like sounds, lights or a combination of sounds and lights, for example, according to the searching signal S2.

In a word, after users generate the trigger signal S1 through the trigger element 112, the multimedia device 110 generates the searching signal S2 through the detection unit 114, and wirelessly transmits the searching signal S2 through the wireless transmitter 116. On the other hand, after the remote control device 120 receives the searching signal S2 through the wireless receiver 122, the alarm unit 124 generates the alarm effect, like sounds, lights or a combination of sounds and lights, according to the searching signal S2. In this case, the users can easily find the remote control device 120, so as to save time for searching the remote control around and effort for recalling where the remote control is.

Please continue to refer to FIG. 1B. The remote control device 120 further includes a signal generation unit 123 and a wireless transmitter 125. The signal generation unit 123 is utilized for generating a remote control signal CMD according to a user's operation. The wireless transmitter 125 is coupled to the signal generation unit 123, and is utilized for wirelessly transmitting the remote control signal CMD to the multimedia device 110. On the other hand, the multimedia device 110 further includes an operating circuit 113, a wireless receiver 115, a function determination unit 117 and a control unit 119. The operating circuit 118 is utilized for realizing functions of the multimedia device 110. The wireless receiver 115 is utilized for receiving the remote control signal CMD sent by the remote control device 120, and transmitting the received remote control signal CMD to the function determination unit 117. The function determination unit 117 then determines an operating function of the operating circuit 113 according to the remote signal CMD to generate a determination result RES. The control unit 119 is coupled to the operating circuit 113 and the function determination unit 117, and is utilized for controlling the operating circuit 113 to perform the operating function according to the determination result RES. As a result, the remote control device 120 can control the multimedia device 110 through the remote control signal CMD. Detailed operations of the multimedia device 110 and the remote control device 120 are known by those of ordinary skill in the art, which are also not a main point of the present invention, and thus not narrated herein.

In the embodiment of the present invention, not only does the remote control device 120 wirelessly transmit the remote control signal CMD to the multimedia device 110, but the multimedia device 110 also wirelessly transmits the searching signal S2, so as to enable the remote control device 120 to generate the alarm effect. In other words, compared to the prior art where the multimedia device can only receive the control signal transmitted by the remote control in one direction, the multimedia device 110 according to the embodiment of the present invention can transmit the searching signal S2 to the remote control device 120 and thus have a two direction communication function. Please note that the multimedia system 10 shown in FIG. 1A and FIG. 1B is merely an exemplary illustration of the present invention. Modifications can certainly be made by those of ordinary skill in the art, and are not restricted. For example, in the embodiment of the present invention, the ways to wirelessly transmit the remote control signal CMD and the searching signal S2 can be the same or different. If they are the same, the wireless transmitter and receiver of the multimedia device 110 and the remote control device 120 can be integrated into a single wireless transceiver module, such that production cost can further be saved.

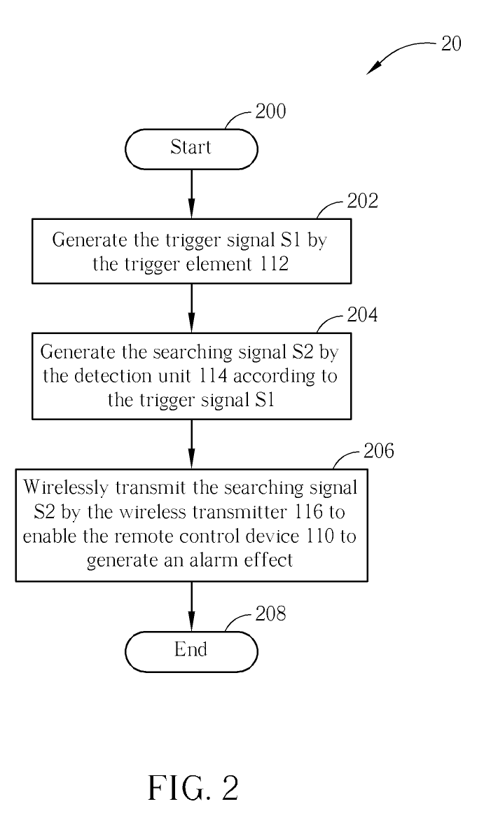

Furthermore, operations of the multimedia device 110 can be summarized as a remote control searching process 20, as shown in FIG. 2. The remote control searching process 20 includes the following steps:

Step 200: Start.

Step 202: Generate the trigger signal S1 by the trigger element 112.

Step 204: Generate the searching signal S2 by the detection unit 114 according to the trigger signal S1.

Step 206: Wirelessly transmit the searching signal S2 by the wireless transmitter 116 to enable the remote control device 110 to generate an alarm effect.

Step 208: End.

Detailed operations of the remote control searching process 20 can be referred to the above descriptions, and are not narrated again herein. Namely, after the wireless receiver 122 of the remote control device 120 receives the searching signal S2, the alarm unit 124 generates the alarm effect, like sounds, lights or a combination of sounds and lights, for example, according to the searching signal S2.

In the prior art, the remote control is easily taken to other places of the house and forgotten. Thus, users often have to spend some time searching for the remote control before they can comfortably watch television programs. If the remote control cannot be found immediately, the users can only rely on buttons on televisions to perform channel selection, which causes great inconvenience to the users. By comparison, the multimedia system of the present invention has a remote control searching mechanism. When the users trigger the searching function, the remote control would make one or multiple alarm messages to enable the users to find the remote control quickly. Therefore, the users can save time for searching the remote control around and effort for recalling the location of the remote control, so as to enhance use convenience.

To sum up, the multimedia device of the present invention sends out the searching signal to enable the remote control to generate the alarm effects, so as to allow the users to find out the remote control quickly.

Those skilled in the art will readily observe that numerous modifications and alterations of the device and method may be made while retaining the teachings of the invention.

What is claimed is:

1. A multimedia system, comprising:
a multimedia device, comprising:
a trigger element, for generating a trigger signal;
a detection unit, coupled to the trigger element, for generating a searching signal when detecting the trigger signal; and
a wireless transmitter, coupled to the detection unit, for wirelessly transmitting the searching signal; and
a remote control device, for wirelessly transmitting a remote control signal to control operations of the multimedia device, the remote control device comprising:
a wireless receiver, for receiving the searching signal; and
an alarm unit, coupled to the wireless receiver, for generating an alarm effect according to the searching signal.

2. The multimedia system of claim 1, wherein the trigger element is a button.

3. The multimedia system of claim 1, wherein the trigger element is a touch pad.

4. The multimedia system of claim 1, wherein the multimedia device further comprises a housing, and the trigger element is installed on the housing.

5. The multimedia system of claim 1, wherein the multimedia device further comprises:
an operating circuit;
a wireless receiver, for receiving the remote control signal;
a function determination unit, coupled to the wireless receiver, for determining an operating function of the operating circuit according to the remote signal, to generate a determination result; and
a control unit, coupled to the operating circuit and the function determination unit, for controlling the operating circuit to perform the operating function according to the determination result.

6. The multimedia system of claim 1, wherein the alarm effect is a combination of sounds and lights.

7. The multimedia system of claim 1, wherein the remote control device further comprises a wireless transmitter, for transmitting the remote control signal to the multimedia device.

8. The multimedia system of claim 1, wherein the multimedia device is a television.

9. A remote control searching method of a multimedia device, for searching a remote control device corresponding to the multimedia device, the remote control device being utilized for wirelessly transmitting a remote control signal to control operations of the multimedia device, the remote control searching method comprising:
utilizing the multimedia device to generate a searching signal; and
wirelessly transmitting the searching signal to enable the remote control device to generate an alarm effect.

10. The remote control searching method of claim 9, wherein the trigger signal is generated by a button of the multimedia device.

11. The remote control searching method of claim 9, wherein the trigger signal is generated by a touch pad of the multimedia device.

12. The remote control searching method of claim 9, wherein the alarm effect is a combination of sounds and lights.

13. The remote control searching method of claim 9, wherein the multimedia device is a television.
